(19) United States
(12) Patent Application Publication
(10) Pub. No.: US 2017/0028780 A1
(43) Pub. Date: Feb. 2, 2017

(54) PNEUMATIC TIRE

(71) Applicant: TOYO TIRE & RUBBER CO., LTD., Osaka (JP)

(72) Inventor: Hiroyuki Haseda, Osaka (JP)

(73) Assignee: TOYO TIRE & RUBBER CO., LTD., Osaka (JP)

(21) Appl. No.: 15/220,928

(22) Filed: Jul. 27, 2016

(30) Foreign Application Priority Data
Jul. 29, 2015 (JP) 2015-150102

(51) Int. Cl. B60C 9/20

(52) U.S. Cl. CPC B60C 9/20; B60C 2009/2016; B60C 2009/2061; B60C 2200/06

(57) ABSTRACT

A belt layer of a pneumatic tire includes a first main working belt, a second main working belt arranged at an outer side of the first main working belt in a tire-radial direction having a cord angle θp2 different from a cord angle Γp1 of the first main working belt in a direction with respect to a tire-circumferential direction, and a reinforcement belt. An absolute value of a cord angle θr of the reinforcement belt is not smaller than 6 degrees and not larger than 9 degrees. The cord angles θp1, θp2, and θr satisfy “−8≦θp1+θp2+θr≦8”.

### CROSS-REFERENCE TO RELATED APPLICATIONS

This application claims priority of Japanese Patent Application No. 2015-150102 filed on Jul. 29, 2015, the content of which is incorporated herein by reference.

### BACKGROUND OF THE INVENTION

Technical Field

The present invention relates to a pneumatic tire.

Related Art

In a pneumatic radial tire for a heavy load used for a vehicle such as a truck or a bus, it has been known that a belt layer arranged between a carcass and a tread portion includes a reinforcement belt with cords having a small inclination angle with respect to the tire-circumferential direction (cord angle) of 0 to 5 degrees (see JP 2002-316513 A, for example) The reinforcement belt is intended to suppress a growth of the tire in the radial direction.

### SUMMARY

The small cord angle of the reinforcement belt ranging from approximately 0 to 5 degrees increases a force for holding a shape of the tread portion to reduce distortion at an end portion of the belt, and therefore is advantageous in view of belt durability.

However, the small cord angle of the reinforcement belt ranging from approximately 0 to 5 degrees causes an excessively large binding force in a tire-radial direction, thereby promoting an increased tendency in the deformation of a tire in the tire-width direction. The increased deformation in the tire-width direction increases the deformation of the tire at an area ranging from a bead portion to a portion having a largest width in a tire cross section. As a result, distortion in the bead portion is increased, causing lower resistance against a defect such as separation in the bead portion (bead durability).

In forces in the tire-width direction (a lateral direction) generated on a tire rotating in a loaded state, a force caused by a tire structure is referred to as a ply steer. For example, in the case where the cord angle of the reinforcement belt is not set to 0 degrees, the ply steer is generated. The ply steer promotes a phenomenon (vehicle drifting) in which such a tendency to skew appears in a vehicle traveling straight. In a conventional pneumatic tire having a reinforcement belt including the tire disclosed in JP 2003-316513 A, suppression of the vehicle drifting caused by the cord angle of the reinforcement belt is not particularly discussed.

It is an object of the present invention to enhance bead durability and effectively suppress vehicle drifting in a pneumatic tire while ensuring an effect of suppressing a growth in a tire-radial direction and belt durability.

An aspect of the present invention provides a pneumatic tire comprising a belt layer arranged between a carcass and a tread portion, wherein the belt layer comprises a first main working belt, a second main working belt arranged at an outer side of the first main working belt in a tire-radial direction, the second main working belt having a cord angle different from a cord angle of the first main working belt in a direction with respect to a tire-circumferential direction, and a reinforcement belt, an absolute value of a cord angle of the reinforcement belt is not smaller than 6 degrees and not larger than 9 degrees, and the following expression is satisfied:

−8≦θp1+θp2+θr≦8

where θp1 denotes the cord angle of the first main working belt (degrees), θp2 denotes the cord angle of the second main working belt (degrees), and θr denotes the cord angle of the reinforcement belt (degrees).

In this specification, a “cord angle” is an acute angle formed by a cord of a belt or a ply with respect to a tire-circumferential direction. In the case where the cord extends in the tire-circumferential direction, the cord angle is 0 degrees. As to a positive or negative sign of the “cord angle”, either of the case where the cord extends leftward apart from a center line in a tire-width direction as seen from a tread surface (left upward direction) or the case where the cord extends rightward apart from the center line (right upward direction) may be defined as positive. In the embodiment which will be described later, the case where the cord extends in the left upward direction is defined as positive.

The cord angle of the reinforcement belt is set to a value not smaller than 6 degrees and not larger than 9 degrees, instead of setting the cord. angle to a small angle such as an angle of not smaller than 0 degrees and not larger than 5 degrees (an angle substantially regarded as 0 degrees or an angle close to such angle). Such configuration can obviate a phenomenon where a binding force in a tire-radial direction generated by the reinforcement belt becomes excessively large, and therefore can suppress the excessively large deformation of the tire in the tire-width direction. As a result, the distortion generated in the bead portion can be suppressed, and therefore bead durability can be enhanced.

A total sum of the cord angle θr of the reinforcement belt, the cord angle θp1 of the first main working belt, and the cord angle θp2 of the second main working belt is set to be not smaller than −8 degrees and not larger than 8 degrees, that is, around 0 degrees. For this reason, a component force in the tire-width direction (lateral direction) of a belt tension in the reinforcement belt is offset by a component force in the tire-width direction (the lateral direction) of a belt tension in each of the first and second main working belts. As a result, a ply steer component is decreased so that vehicle drifting can be suppressed effectively.

When the absolute value of the cord angle θr of the reinforcement belt is set to be not smaller than 6 degrees and not larger than 9 degrees, the effect of suppressing a growth in a tire-radial direction is reduced as compared with the case where the absolute value of the cord angle θr is not smaller than 0 degrees and not larger than 5 degrees. However, the absolute value of the cord angle θr is 9 degrees at a maximum. Therefore, the binding force in the tire-radial direction is prevented from being reduced excessively. Therefore, it is possible to ensure the effect of suppressing a growth in the tire-radial direction which is required. Moreover, a sufficient shape holding force of the tread portion can be obtained and distortion in a belt end portion can be reduced. Consequently, necessary belt durability can be ensured,

As described above, according to the pneumatic tire of the present invention, it is possible to enhance the belt durability and the bead durability, and furthermore, effectively suppress the vehicle drifting while ensuring the effect of suppressing the growth in the radial direction.

Preferably, a width of the reinforcement belt is equal to or wider than 50% of a tire section width and not wider than a width of a narrower one of the first and second main working belts.

The width of the reinforcement belt is equal to or wider than 50% of a tire-section width. That is, the reinforcement belt has a sufficiently wide width instead of the narrow width. Due to the above-mentioned reasons, the tire can ensure a desired effect of suppressing a growth of the tire in the radial direction. Further, the tire can acquire a sufficient force for holding a shape of the tread portion so that distortion at an end portion of the belt can be reduced whereby the tire can ensure required belt durability. The width of the reinforcement belt is not wider than either narrower one of the first and second main working belts. Accordingly, the distortion generated in the reinforcement belt can be reduced.

Preferably, the reinforcement belt is arranged between the first main working belt and the second main working belt.

Arranging the reinforcement belt between the first main working belt and the second main working belt can alleviate breakage of the cord in the vicinity of a road contact surface, and therefore cord breakage can be effectively prevented.

The cord angles of the first and second main working belts can be respectively 20±10 degrees. Further, the cord angles of the first and second main working belts can be respectively 17±5 degrees.

The belt layer can further comprise a protection belt arranged at an outer side of the second main working belt in the tire-radial direction.

The belt layer can further comprise a buffer belt arranged at an inner side of the first main working belt in the tire-radial direction.

The pneumatic tire can have an aspect ratio of not larger than 70% and a nominal section width of not smaller than 365.

According to the pneumatic tire of the present invention, it is possible to enhance bead durability, and furthermore, effectively suppress vehicle drifting while ensuring an effect of suppressing a growth in a radial direction and belt durability.

### BRIEF DESCRIPTION OF THE DRAWINGS

The foregoing and the other features of the present invention will become apparent from the following description and drawings of an illustrative embodiment of the invention in which:

FIG. 1 is a meridian sectional view of a pneumatic tire according to an embodiment of the present invention;

FIG. 2 is a development view of a belt layer;

FIG. 3 is a schematic partial sectional view of the pneumatic tire when a load is applied;

FIG. 4 is a schematic view for explaining components in a tire width direction (lateral direction) of tension in a main working belt and a reinforcement belt;

FIG. 5 is a meridian sectional view of a pneumatic tire according to a modification; and

FIG. 6 is a meridian sectional view of a pneumatic tire according to Comparative Example 1.

### DETAILED DESCRIPTION OF EMBODIMENTS

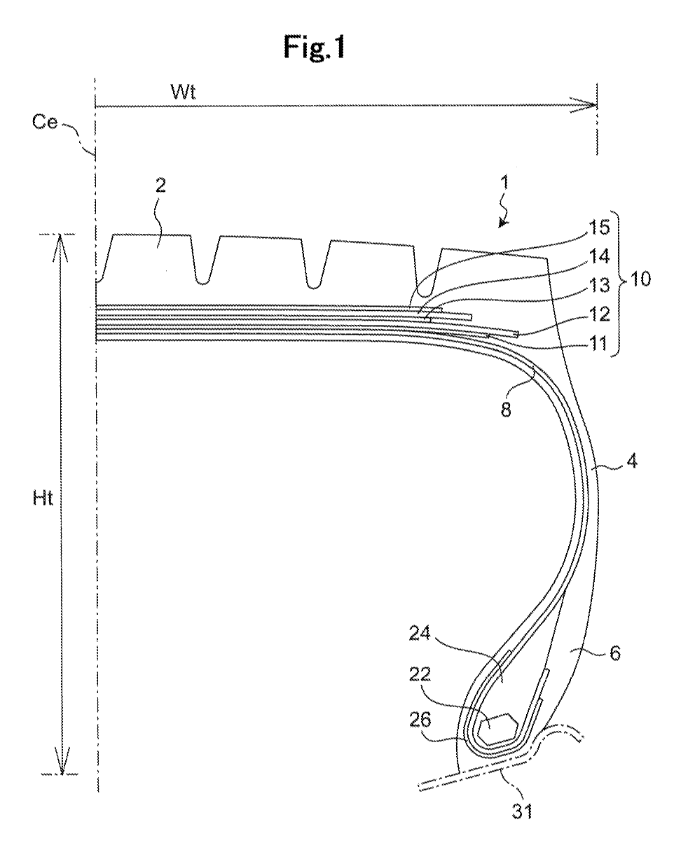

FIG. 1 shows a rubber pneumatic tire (hereinafter referred to as “tire”) 1 according to an embodiment of the present invention. The tire 1 is a pneumatic radial tire for a heavy load used for a vehicle such as a truck or a bus. Further, the tire 1 is a low-profile tire having an aspect ratio of not larger than 70%. An aspect ratio is defined as a ratio of a maximum tire-section height Ht to a maximum tire-section width Wt. Specifically, a size of the tire 1 in this embodiment is 445/50R22.5 (expressed in accordance with ISO standard).

The tire 1 includes a tread portion 2, a pair of side portions 4, and a pair of bead portions 6. The bead portions 6 are respectively formed on inner edge portions of the side portions 4 in a tire-radial direction (edge portions of the side portions 4 opposite to the tread portion 2). A carcass 8 is arranged between the pair of bead portions 6. An inner liner (not shown in the drawing) is arranged in an innermost peripheral surface of the tire 1. A belt layer 10 is arranged between the carcass 8 and a tread surface of the tread portion 2. In other words, in the tread portion 2, the belt layer 10 is arranged at an outer side of the carcass 8 in the tire-radial direction. As described later in detail, in this embodiment, the belt layer 10 includes five belts 11 to 15.

The bead portion 6 includes a bead core 22, a bead filler 24, and a chafer 26. Around the bead core 22, an end portion of the carcass 8 in a tire-width direction is wound up from an inner side to an outer side in a tire-width direction along the bead filler 24. The chafer 26 is arranged around the bead filler 24 so as to be arranged adjacently to an outer side of the end portion of the carcass S.

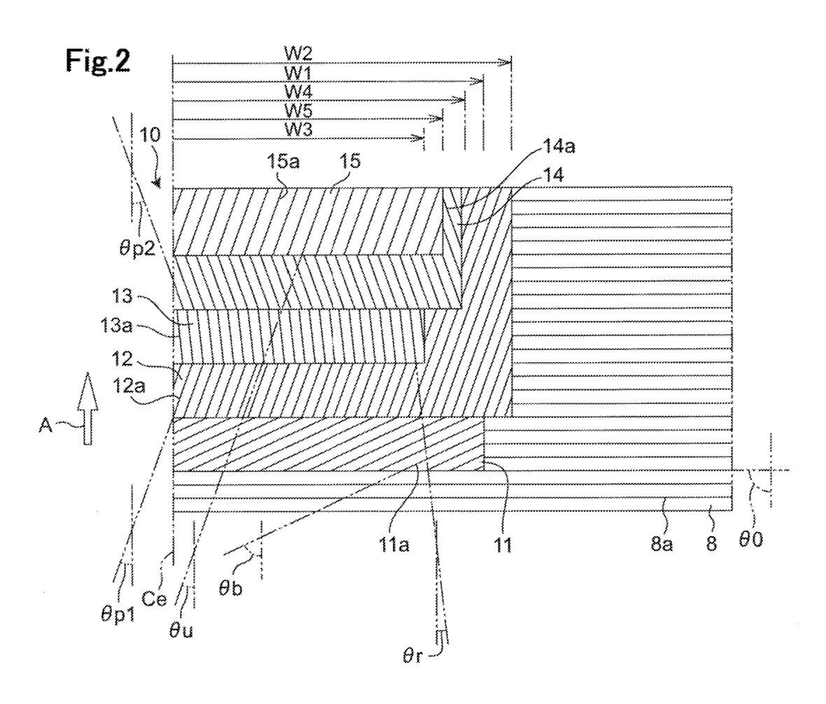

Referring to FIGS. 1 and 2, the carcass 6 in this embodiment is formed of one carcass ply, and is formed of a plurality of carcass cords 8a arranged parallel to each other and coated by a rubber layer. Each carcass cord 8a is arranged so as to extend in the tire-radial direction, and has an angle θ0 with respect to a tire-circumferential direction (cord angle) set to 90 degrees. In FIGS. 1 and 2, symbol Ce indicates a center line in the tire-width direction. The direction along which the center line Ce extends is a tire-radial direction. While the carcass cord 8a in this embodiment is made of steel, the carcass cord 8a can be made of organic fibers.

Referring to FIGS. 1 and 2, the belt layer 10 in this embodiment includes five belts arranged in an overlapping manner. These belts include a buffer belt 11, a first main working belt 12, a reinforcement belt 13, a second main working belt 14, and a protection belt 15.

The buffer belt 11 is arranged adjacently to an outer side of the carcass 6 in the tire-radial direction. The first main working belt 12 is arranged adjacently to an outer side of the buffer belt 11 in the tire-radial direction. The second main working belt 14 is arranged at an outer side of the first main working belt 12 in the tire-radial direction. The reinforcement belt 13 is arranged between the first main working belt 12 and the second main working belt 14. That is, the reinforcement belt 13 is arranged adjacently to the outer side of the first main working belt 12 in the tire-radial direction, and is also arranged adjacently to an inner side of the second main working belt 14 in the tire-radial direction. The protection belt 15 is arranged adjacently to an outer side of the second main working belt 14 in the tire-radial direction.

Main functions of the first and second main working belts 12 and 14 are to apply a binding force in the tire-radial direction to the carcass 8 (with a cord angle θ0 being set to 90 degrees) A main function of the reinforcement belt 13 is to compensate for the shortage in a binding force in the tire-radial direction which is applied to the tire 1 by the first and second main working belts 12 and 14. A main function of the protection belt 15 is to enhance external damage resistance of the tire 1 by protecting the first and second main working belts 12 and 14. A main function of the buffer belt 11 is to enhance impact resistance of the tire 1.

Each of these belts 11 to 15 is formed of a plurality belt cords 11a, 12a, 13a, 14a, and 15a arranged parallel to each other and coated by a rubber layer.

Referring FIG. 2, inclination angles (cord angles) θb, θp1, θr, θp2, and θu of belt cords 11a to 15a of belts 11 to 15 forming the belt layer 10 will be described. In the description hereinafter, regarding the cord angles θb, θp1, θr, θp2, and θu, a direction along which the belt cords 11a to 15a extend rightward and away from the center line Ce in the tire-width direction when an arrow A in FIG. 2 is set as a reference direction can be referred to as “right upward direction”. Similarly, a direction along which the belt cords ha to 15a extend leftward and away from the center line Ce in the tire-width direction when the arrow A in FIG. 2 is set as the reference direction can be referred to as “left upward direction”.

In this embodiment, the cord angles θb, θp1, θr, θp2, and θu of the belts 11 to 15 constituting the belt layer 10 have positive signs when the belt cords ha to 15a extend in the left upward direction and have negative signs when the belt cords ha to 15a extend in the right upward direction. This is the same as in the cord angle θ0 of the carcass 8. Alternatively, the cord angles θ0, θb, θp1, θr, θp2, and θu may have positive signs when the belt cords extend in the right upward direction and have negative signs when the belt cords extend in the left upward direction.

The cord angle θp1 of the belt cord 12a of the first main working belt 12 is set to −18 degrees (right upward direction) in this embodiment. An absolute value of the cord angle θp1 can be set in a range of 20±10 degrees, and preferably set in a range of 17±5 degrees.

The cord angle θp2 of the belt cord 14a of the second main working belt 14 is set to 12 degrees (left upward direction) in this embodiment. An absolute value of the cord angle θp2 can be set in a range of 20±10 degrees, and preferably set in a range of 17±5 degrees.

The cord angles θp1 and θp2 of the first and second main working belts 12 and 14 are set in such a manner that the belt cords 12a and 14a extend in different directions with respect to the center line Ce in the tire-width direction. In other words, one of the cord angles θp1 and θp2 is set to extend in the right upward direction and the other is set to extend in the left upward direction.

The cord angle θr of the belt cord 13a of the reinforcement belt 13 is set to 6 degrees (left upward direction) in this embodiment. An absolute value of the cord angle θr can be set in a range which is not smaller than 6 degrees and not larger than 9 degrees.

The cord angle θb of the belt cord 11a of the buffer belt 11 is set to −65 degrees (right upward direction) in this embodiment. The cord angle θb is set in a range of 60±15 degrees.

The cord angle θu of the belt cord 15a of the protection belt 15 is set to −20 degrees (right upward direction) in this embodiment The cord angle θu is set in a range of 20±10 degrees.

Numeric values (including upper and lower limit values within a range of numeric values of absolute values) of the cord angles θb, θp1, θr, θp2, and θu are not necessarily geometrically strict values, as long as substantially inevitable errors are permitted and functions required for the belts 11 to 15 are satisfied. This is the same for the cord angle θ0 of the carcass cord 8a.

The cord angles θb, θp1, θr, θp2, and θu of the belts 11 to 15 can be coordinated as shown in the following Table 1.

TABLE 1

| | | Settable range of angle |
|---|---|---|
| | Embodiment | (Absolute Value) |
| Buffer belt | −65 degrees | 60 ± 15 degrees |
| | (right upward | (right upward direction) |
| | direction) | |
| First main | −17 degrees | 20 ± 10 degrees |
| working belt | (right upward | (17 ± 5 degrees) |
| | direction) | (right upward direction) |
| Reinforcement | 7 degrees | Not smaller than |
| belt | (left upward | 6 degrees and not |
| | direction) | larger than 9 degrees |
| Second main | 17 degrees | 20 ± 10 degrees |
| working belt | (left upward | (17 ± 5 degrees) |
| | direction) | (right upward direction) |
| Protection | −20 degrees | 20 ± 10 degrees |
| belt | (right upward | (right upward direction) |
| | direction ) | |

Main data except for the cord angles of the belts 11 to 15 in this embodiment are shown in the following Table 2.

TABLE 2

| | | | Thickness of | | |
|---|---|---|---|---|---|
| | | Diameter | cord including | Number | |
| | Raw | of cord | cover rubber | of ends | Width |
| | material | (mm) | (mm) | (EPI) | (mm) |
| Buffer belt | Steel | 1.1 | 1.7 | 12 | W1 = 345 |
| First main | Steel | 1.4 | 2.6 | 12 | W2 = 370 |
| working belt | | | | | |
| Reinforcement | Steel | 1.1 | 1.7 | 12 | W3 = 290 |
| belt | | | | | |
| Second main | Steel | 1.4 | 2.6 | 12 | W4 = 325 |
| working belt | | | | | |
| Protection belt | Steel | 1.1 | 1.9 | 9 | W5 = 295 |

As shown in Table 2, in this embodiment, a width W4 (325 mm) of the second main working belt 14 which is arranged relatively outer side in the tire-radial direction is set narrower than a width W2 (370 mm) of the first main working belt 12 which is arranged relatively inner side, in the tire-radial direction.

A width W3 of the reinforcement belt 13 is set to a value equal to or wider than 50% of a maximum tire-section width Wt (W3≧0.5 Wt). In this embodiment, the maximum tire-section width Wt is a value set under conditions where the tire 1 is mounted on a predetermined rim (a rim 31 is schematically shown in FIG. 1) , the tire 1 is filled with air until an inner pressure reaches a predetermined internal pressure (830 kPa which is an internal pressure determined by the Tire and Rim Association, Inc (TRA)), and the tire 1 is in an unloaded state. The width W3 of the reinforcement belt 13 is set narrower than a width of either one of the first and second main working belts 12 and 14 having a narrower width than the other (W3<W2, W4). In this embodiment, the width W3 of the reinforcement belt 13 is set to 290 mm. Accordingly, the width W3 of the reinforcement belt 13 is equal to or wider than 50% of a maximum tire-section width Wt (440 mm) under the above-mentioned conditions, and is narrower than the width W4 (325 mm) of the second main working belt 14 having a narrower width.

The absolute value of the cord angle θr of the reinforcement belt 13 is set to an angle of not smaller than 6 degrees and not larger than 9 degrees, instead of a small angle of not smaller than 0 degrees to not more than 5 degrees (an angle which can be substantially regarded as 0 degrees or an angle close to 0 degrees) Such configuration can prevent a binding force in a tire-radial direction generated by a reinforcement belt 13 from becoming excessively large, and therefore the excessively large deformation of the tire in the tire-width direction can be suppressed. Since the excessively large deformation of the tire in the tire-width direction can be suppressed, the distortion generated in the bead portion 6 can be suppressed, and therefore bead durability (resistance against the generation of a defect such as separation in the bead portion) can be enhanced.

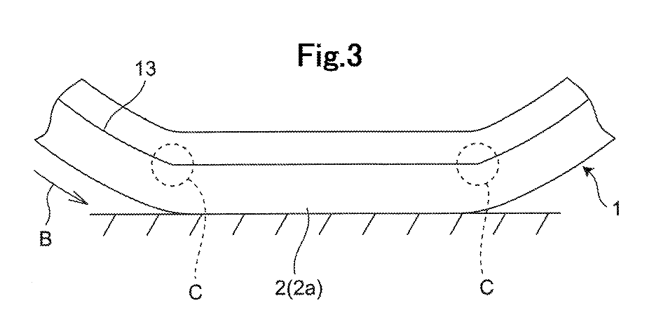

As conceptually shown in FIG. 3, in a loaded state (a state where the tire 1 is mounted on a vehicle), belt cords 13a of the reinforcement belt 13 are bent in regions (symbols C) of a tread surface of the tread portion 2 in front of and behind a road contact surface 2a in the rotational direction of the tire indicated by an arrow B. The smaller cord angle θr, the more conspicuous the bending of the belt cords 13a becomes. By setting the cord angle θr to a value not smaller than 6 degrees and not larger than 9 degrees, compared to a case where the cord angle θr is set to a small angle such as an angle not smaller than 0 degrees and not larger than 5 degrees, bending of the belt cord 13a of the reinforcement belt 13 in the vicinity of the road contact surface 2a can be alleviated, and therefore cord breakage can be effectively prevented.

As described above, the width W3 of the reinforcement belt 13 is set narrower than the width W4 of the second main working belt 14 which is narrower one of the first and second main working belts 12, 14. Such configuration can also effectively prevent cord breakage of the belt cord 13a of the reinforcement belt.

As described above, the reinforcement belt 13 is arranged between the first main working belt 12 and the second main working belt 14. Due to such an arrangement, the reinforcement belt 13 is protected by the first and second main working belts 12, 14, and therefore cord breakage of the belt cord 13a of the reinforcement belt 13 caused due to bending of the cord in the vicinity of the road contact surface 2a (symbols C in FIG. 3) can be effectively prevented.

From these reasons, the cord breakage of the reinforcement belt 13 can be prevented effectively.

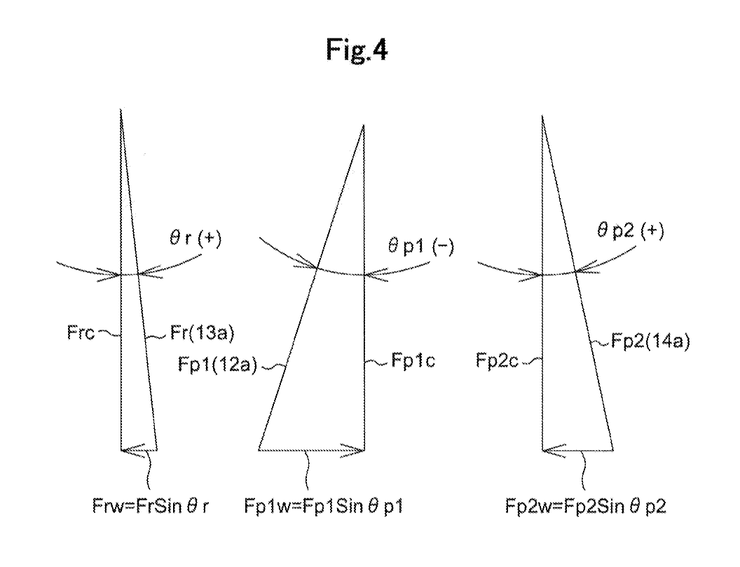

With reference to FIG. 4, a belt tension Fr of the belt cord 13a of the reinforcement belt 13 can be decomposed into a component Frc in the tire-circumferential direction and a component Frw in the tire-width direction (lateral direction). Similarly, belt tensions Fp1 and Fp2 of the belt cords 12a and 14a of the first and second main working belts 12 and 14 can also be decomposed into components Fp1c and Fp2c in the tire-circumferential direction and components Fp1w and Fp2w in the tire-width direction (the lateral direction). The components Frw, Fp1w, and Fp2w in the tire-width direction (the lateral direction) can be expressed as shown in the following Expressions (1) to (3) by using the cord angles θr, θp1, and θp2.

Frw=Frsinθr (1)

Fp1w=Fp1sinθp1 (2)

Fp2w=Fp2sinθp2 (3)

The component Frw in the tire-width direction (the lateral direction) of the tension Fr of the reinforcement belt 13 with the reinforcement belt 13 having the cord angle θr (the absolute value being not smaller than 6 degrees and not larger than 9 degrees as described above) increases a ply steer component. The ply steer component is one of forces in the tire-width direction (the lateral direction) in which its generating direction varies depending on rotating directions (normal and reverse rotations) of the tire 1 when the tire 1 rotates in the loaded state.

As described above, one of the cord angles θp1 and θp2 of the first and second main working belts 12 and 14 is set to the right upward direction and the other is set to the left upward direction. In other words, one of the cord angles θp1 and θp2 of the first and second main working belts 12 and 14 has the positive or negative sign which is the same as that of the cord angle θr of the reinforcement belt 13, and the other has the positive or negative sign which is different from the cord angle θr of the reinforcement belt 13. Particularly, in this embodiment, the reinforcement belt 13 is arranged between the first main working belt 12 and the second main working belt 14. Therefore, the tensions Fp1 and Fp2 of the first and second main working belts 12 and 14 and the tension Fr of the reinforcement belt 13 can be regarded to be substantially the same. For these reasons, the cord angles θp1, θp2, and θr of the first main working belt 12, the second main working belt 14, and the reinforcement belt 13 are set such that the total sum of the cord angles θp1, θp2, and θr is substantially zero. Consequently, the component Frw in the tire-width direction (the lateral direction) of the tension Fr of the reinforcement belt 13 (the ply steer component caused by the cord angle θr of the reinforcement belt 13) can be offset by the components Fp1w and Fp2w in the tire-width direction (the lateral direction) of the belt tensions Fp1 and Fp2 of the first and second main working belts 12 and 14.

For the reason described above, the total sum of the cord angle θp1 of the first main working belt, the cord angle θp2 of the second main working belt, and the cord angle θr of the reinforcement belt is set to be not smaller than −8 degrees and not larger than 8 degrees, that is, around 0 degrees, as shown in the following Expression (4) .

−8≦θp1+θp2+θr≦8 (4)

The cord angles θp1, θp2, and θr are set as shown in the following Expression (4) to offset the component Frw in the tire-width direction (the lateral direction) of the tension Fr of the reinforcement belt 13 by the components Fp1w and Fp2w in the tire-width direction (the lateral direction) of the belt tensions Fp1 and Fp2 of the first and second main working belts 12 and 14. Consequently, the ply steer component is decreased so that vehicle drifting can be suppressed effectively.

By setting the cord angle θ3 of the reinforcement belt 13 to a value not smaller than 6 degrees and not larger than 9 degrees, an effect of suppressing a growth of the tire 1 in the radial direction is reduced compared to the case where the cord angle θ3 is set to a value not smaller than 0 degrees and not larger than 5 degrees. However, the cord angle θr of the reinforcement belt 13 is 9 degrees at maximum, and therefore there is no possibility that a binding force in the tire-radial direction is excessively reduced. Further, as described above, the width W3 of the reinforcement belt 13 is equal to or wider than 50% of a maximum tire-section width Wt. That is, a width of the reinforcement belt 13 is not narrow but is sufficiently wide. Due to these reasons, the tire 1 can ensure a required effect of suppressing a growth of the tire 1 in the radial direction. Further, the tire can acquire a sufficient force for holding a shape of the tread portion 2 so that distortion at the end portion of the belt can be reduced whereby the tire can ensure required belt durability. The width W3 of the reinforcement belt 13 is narrower than a width of the narrower one of the first and second main working belts 12 and 14 (widths W2, W4). Accordingly, the distortion generated in the reinforcement belt 13 can be reduced.

As described above, according to the pneumatic tire of the present invention, it is possible to enhance bead durability, and furthermore, effectively suppress vehicle drifting while ensuring an effect of suppressing a growth in a radial direction and belt durability.

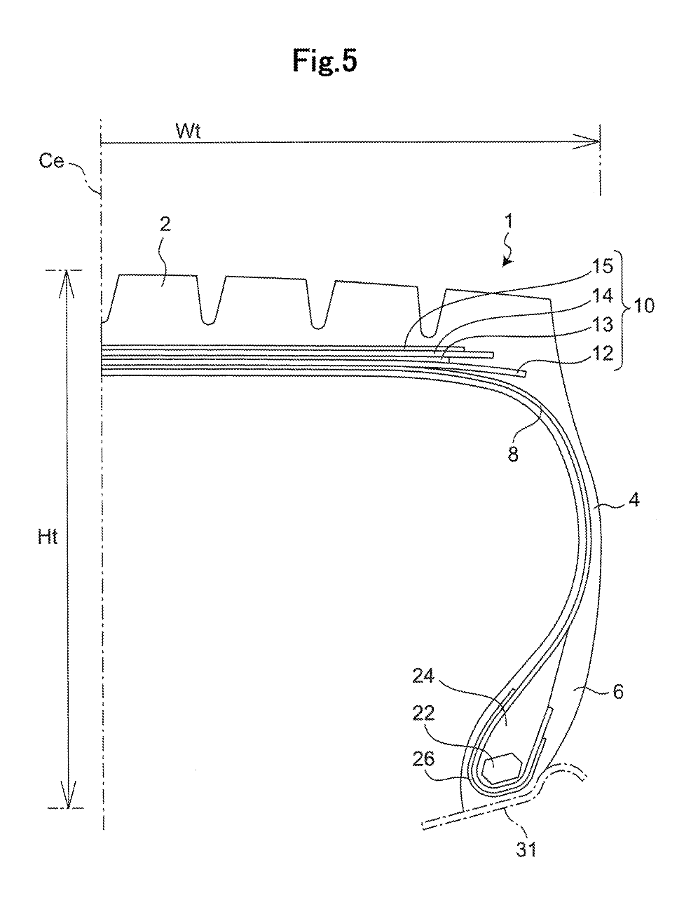

FIG. 5 shows a modification of the tire 1 according to the embodiment. In this modification, a belt layer 10 includes four belts, that is, a first main working belt 12, a reinforcement belt 13, a second main working belt 14, and a protection belt 15, but does not include a buffer belt 11. Even in the case where the belt layer 10 does not include the buffer belt 11, bead durability can be enhanced while an effect of suppressing a growth of the tire 1 in the radial direction and belt durability are also ensured.

### EXAMPLES

Tires according to Comparative Examples 1 to 4 and Examples 1 to 4 shown in the following Table 3 were subjected to an evaluation test performed for evaluating belt durability and vehicle drifting. Assume that data which are not described particularly hereinafter are shared in common by the tires according to Comparative Examples 1 to 4 and Examples 1 to 4. Particularly, in all of Comparative Examples 1 to 4 and Examples 1 to 4, a tire size is set to 445/50R22.5. Moreover, in all of Comparative Examples 1 to 4 and Examples 1 to 4, the width W2 of the first main working belt 12 is set to 365 mm and the width W4 of the second main working belt 14 is set to 340 mm. Furthermore, in all of Comparative Examples 1 to 4 and Examples 1 to 4, the width W3 of the reinforcement belt 13 is set to 290 mm.

TABLE 3

| | | Compar- | Compar- | Compar- | Example 1 | Example 2 | Example 3 | Example 4 |
|---|---|---|---|---|---|---|---|---|
| | Compar- | ative | ative | ative | Cord angle θr | Cord angle θr | Cord angle θr | Cord angle θr |
| | ative | Example 2 | Example 3 | Example 4 | being lower | being upper | being upper | being lower |
| | Example 1 | Reinforcemen | θp1 + θp2 + | θp1 + θp2 + | limit value, | limit value, | limit value, | limit value, |
| | No | belt in circum- | θr being | θr being | θp1 + θp2 + θr | θp1 + θp2 + | θp1 + θp2 + θr | θp1 + θp2 + θr |
| | reinforce- | ferential | excessively | excessively | being around | θr being | being upper | being around |
| Note | ment belt | direction | large | small | center value | center value | limit value | lower limit value |
| Cord angle θr | — | 0 | 9 | 6 | 6 | 9 | 9 | 6 |
| (degrees) of | | | | | | | | |
| reinforcement belt | | | | | | | | |
| Cord angle θp1 | −17 | −17 | −16 | −28 | −18 | −21 | −17 | −22 |
| of first main | | | | | | | | |
| working belt | | | | | | | | |
| Cord angle θp2 | 17 | 17 | 17 | 12 | 12 | 12 | 16 | 12 |
| of second main | | | | | | | | |
| working belt | | | | | | | | |
| θp1 + θp2 + θr | — | 0 | 10 | −10 | 0 | 0 | 8 | −4 |
| Belt durability | 100 | 130 | 110 | 123 | 123 | 110 | 110 | 123 |
| Bead durability | 100 | 90 | 230 | 110 | 110 | 120 | 120 | 115 |
| Vehicle drifting | 100 | 100 | 83 | 83 | 100 | 100 | 90 | 95 |

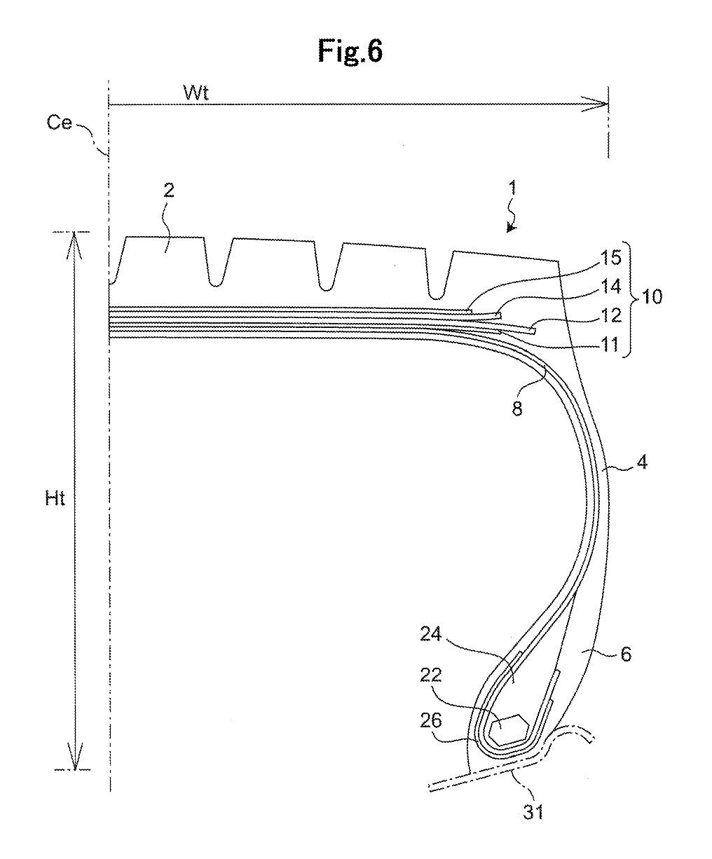

The belt layer 10 according to Comparative Example 1 shown in FIG. 6 does not include the reinforcement belt 13, but includes the buffer belt 11, the first main working belt 12, the second main working belt 14, and the protection belt 15.

In the tire according to Comparative Example 2, the cord angle θr of the reinforcement belt 13 is 0 degrees, which is smaller than the lower limit value of the range (not smaller than 6 degrees and not larger than 9 degrees) of the cord angle θr according to the present invention.

In the tire according to Comparative Example 3, the total sum of the belt angles θp1 and θp2 of the first and second main working belts 12 and 14 and the cord angle θr of the reinforcement belt 13 is 10 degrees, which is larger than the upper limit value of the range (not smaller than −8 degrees and not larger than 8 degrees) according to the present invention.

In the tire according to Comparative Example 4, the total sum of the belt angles θp1 and θp2 of the first and second main working belts 12 and 14 and the cord angle θr of the reinforcement belt 13 is −10 degrees, which is smaller than the lower limit value of the range (not smaller than −8 degrees and not larger than 8 degrees) according to the present invention.

In the tire according to Example 1, the cord angle θr of the reinforcement belt 13 is set to 6 degrees, which is the lower limit value of the range (not smaller than 6 degrees and not larger than 9 degrees) according to the present invention. Moreover, in Example 1, the total sum of the belt angles θp1 and θp2 of the first and second main working belts 12 and 14 and the cord angle θr of the reinforcement belt 13 is set to 0 degrees, which is the center value of the range (not smaller than −8 degrees and not larger than 8 degrees) according to the present invention.

In the tire according to Example 2, the cord angle θr of the reinforcement belt 13 is set to 9 degrees, which is the upper limit value of the range (not smaller than 6 degrees and not larger than 9 degrees) according to the present invention. Moreover, in Example 2, the total sum of the belt angles θp1 and θp2 of the first and second main working belts 12 and 14 and the cord angle θr of the reinforcement belt 13 is set to 0 degrees, which is the center value of the range (not smaller than −8 degrees and not larger than 8 degrees) according to the present invention.

In the tire according to Example 3, the cord angle θr of the reinforcement belt 13 is set to 9 degrees, which is the upper limit value of the range (not smaller than 6 degrees and not larger than 9 degrees) according to the present invention. Moreover, in Example 3, the total sum of the belt angles θp1 and θp2 of the first and second main working belts 12 and 14 and the cord angle θr of the reinforcement belt 13 is set to 8 degrees, which is the upper limit value of the range (not smaller than −8 degrees and not larger than 8 degrees) according to the present invention.

In the tire according to Example 4, the cord angle θr of the reinforcement belt 13 is set to 6 degrees, which is the lower limit value of the range (not smaller than 6 degrees and not larger than 9 degrees) according to the present invention. Moreover, in Example 4, the total sum of the belt angles θp1 and θp2 of the first and second main working belts 12 and 14 and the cord angle θr of the reinforcement belt 13 is set to −4 degrees, which is a value around the lower limit value of the range (not smaller than −6 degrees and not larger than 8 degrees) according to the present invention.

In this evaluation test, the belt durability, the bead durability, and the vehicle drifting were evaluated.

In the evaluation of the belt durability, a tire having a tire size of 445/50R22.5 was mounted on a wheel having a rim size of 22.5×14.00 (predetermined rim), and the tire was filled with air having a pressure of 930 kPa (a value obtained by adding 100 kPa to 830 kPa which is an internal pressure determined by TRA). A maximum tire-section width Wt when no load is applied was 440 mm. Each tire mounted on the wheel was mounted on a drum tester and a traveling test was performed under conditions where a speed is sec to 40 km/h and a load is set to 54.4 kN. As shown in Table 3, a traveling distance of the tire before breakage of the tire is expressed as an index.

In the evaluation of the bead durability, a tire having a tire size of 445/50R22.5 was mounted on a wheel having a rim size of 22.5×14.00 (predetermined rim) , and the tire was filled with air having a pressure of 900 kPa (a value obtained by adding 70 kPa to 830 kPa which is an internal pressure determined by TRA). Each tire mounted on the wheel was mounted on a drum tester and a traveling test was performed under conditions where a speed is set to 40 km/h and a load is set to 72.5 kN. As shown in Table 3, a traveling distance of the tire before breakage of the tire is expressed as an index.

In the evaluation of the vehicle drifting, a tire having a tire size of 445/50R22.5 was mounted on a wheel having a rim size of 22.5×14.00 (predetermined rim) , and the tire was filled with air having a pressure of 700 kPa. Each tire mounted on the wheel was mounted on a drum tester and a traveling test was performed under conditions where a speed is set to 60 km/h and a load is set to 47.9 kN. As shown in Table 3, a ply steer component, which is a value obtained by subtracting a lateral force deviation (average value of fluctuation of a force in the tire-width direction or in the lateral direction) at the time of reverse rotation from a lateral force deviation at the time of normal rotation, and dividing the obtained value by two, is expressed as an index.

In all of the belt durability, the bead durability, and the vehicle drifting, assuming the performance of the tire according to Comparative Example 1 as 100, performances of tires according to the remaining Comparative Examples 2 to 4 and Examples 1 to 4 was indexed. As to the belt durability, the belt durability is favorable if the index is equal to or greater than 110. As to the bead durability, the bead durability is favorable if the index is equal to or greater than 110. As to the vehicle drifting, the vehicle drifting is suppressed effectively if the index is equal to or greater than 90.

In all of Examples 1 to 4, the index of the belt durability is equal to or greater than 110, showing that favorable belt durability is obtained. Moreover, in all of Examples 1 to 4, the index of the bead durability is equal to or greater than 110, showing that favorable bead durability is obtained. Further, in all of Examples 1 to 4, the index of the vehicle drifting is equal to or greater than 90, showing that the vehicle drifting can be suppressed effectively.

In the tire according to Comparative Example 1, the index of the vehicle drifting is 100. However, in Comparative Example 1, the index of the belt durability is 100, showing that the belt durability is poor. Moreover, in Comparative Example 1, the index of the bead durability is 100, showing that the bead durability is poor.

In the tire according to Comparative Example 2, the index of the vehicle drifting is 100 and the index of the belt durability is 130. However, in Comparative Example 2, the cord angle θ3 of the reinforcement belt 13 is set to 0 degrees (circumferential-direction belt). Therefore, the binding force in the tire-radial direction is excessively great so that excessive deformation in the tire-width direction cannot be suppressed. For this reason, the index of the bead durability according to Comparative Example 2 is 90, showing that the bead durability is poor.

In the tire according to Comparative Example 3 in which the total sum of the belt angles θp1 and θp2 of the first and second main working belts 12 and 14 and the cord angle θr of the reinforcement belt 13 is 10 degrees, which is larger than the upper limit value of the range (not smaller than −8 degrees and not larger than 8 degrees) according to the present invention, the index of the belt durability is 110 but the index of the vehicle drifting is 83. Therefore, the vehicle drifting cannot be suppressed effectively. Moreover, in Comparative Example 3, the index of the bead durability is 90, showing that the bead durability is poor.

In the tire according to Comparative Example 4 in which the total sum of the belt angles θp1 and θp2 of the first and second main working belts 12 and 14 and the cord angle θr of the reinforcement belt 13 is −10 degrees, which is smaller than the lower limit value of the range (not smaller than −8 degrees and not larger than 8 degrees) according to the present invention, the index of the belt durability is 123 and the index of the bead durability is 110, but the index of the vehicle drifting is 83. Therefore, the vehicle drifting cannot be suppressed effectively.

As described above, by comparing the tires according to Comparative Examples 1 to 4 and Examples 1 to 4, it is understood that, according to the pneumatic tire of the present invention, all of the belt durability, the bead durability, and the suppression of the vehicle drifting can be enhanced.

The tire according to the present invention is favorably applicable to a pneumatic tire (so-called super single tire) having an aspect ratio of not larger than 70% and a nominal section width of not smaller than 365. The tire according to the present invention is also applicable to a pneumatic tire having a small aspect ratio and falling outer side a range of a pneumatic radial tire for heavy load.

What is claimed is:

1. A pneumatic tire comprising a belt layer arranged between a carcass and a tread portion,
wherein the belt layer comprises
a first main working belt,
a second main working belt arranged at an outer side of the first main working belt in a tire-radial direction, the second main working belt having a cord angle different from a cord angle of the first main working belt in a direction with respect to a tire-circumferential direction, and
a reinforcement belt,
an absolute value of a cord angle of the reinforcement belt is not smaller than 6 degrees and not larger than 9 degrees, and
the following expression is satisfied:
−8≦θp1+θp2+θr≦8
where θp1 denotes the cord angle of the first main working belt (degrees), θp2 denotes the cord angle of the second main working belt (degrees), and θr denotes the cord angle of the reinforcement belt (degrees).

2. The pneumatic tire according to claim 1, wherein a width of the reinforcement belt is equal to or wider than 50% of a tire-section width and not wider than a width of a narrower one of the first and second main working belts.

3. The pneumatic tire according to claim 1, wherein the reinforcement belt is arranged between the first main working belt and the second main working belt.

4. The pneumatic tire according to claim 1, wherein the absolute values of the cord angles of the first and second main working belts are respectively 20±10 degrees.

5. The pneumatic tire according to claim 4, wherein the absolute values of the cord angles of the first and second main working belts are respectively 17±5 degrees.

6. The pneumatic tire according to claim 1, wherein the belt layer further comprises a protection belt arranged at an outer side of the second main working belt in the tire-radial direction.

7. The pneumatic tire according to claim 6, wherein the belt layer further comprises a buffer belt arranged at an inner side of the first main working belt in the tire-radial direction.

8. The pneumatic tire according to claim 1, wherein the pneumatic tire has an aspect ratio of not larger than 70% and a nominal section width of not smaller than 365.
